(19) United States
(12) Patent Application Publication
(10) Pub. No.: US 2024/0199376 A1
(43) Pub. Date: Jun. 20, 2024

(54) GOVERNOR ASSEMBLY FOR AN ELEVATOR

(71) Applicant: Otis Elevator Company, Farmington, CT (US)

(72) Inventors: Javier Muñoz Sotoca, Rivas-Vaciamadrid (ES); Borja de Diego Restrepo, Madrid (ES)

(21) Appl. No.: 18/364,974

(22) Filed: Aug. 3, 2023

(30) Foreign Application Priority Data
Dec. 20, 2022 (EP) 22383242.9

(51) Int. Cl. B66B 5/04; B66B 1/30; B66B 1/32; B66B 1/34; B66B 5/16

(52) U.S. Cl. CPC B66B 5/046; B66B 1/30; B66B 1/32; B66B 1/3461; B66B 5/16; B66B 15/04

(57) ABSTRACT

A governor assembly for an elevator system. The governor assembly includes: a sheave configured to rotate about a central axis (X-X) thereof at a speed related to the speed of movement of an elevator car; a plurality of masses mounted to the sheave for rotation therewith about the central axis (X-X) and configured to move from a first radial position to a second radial position, radially outward of the first radial position, when a speed of rotation of the sheave meets or exceeds a set speed; a sensor configured to detect that the plurality of masses have reached the second radial position; and a brake moveable from a non-braking position in which the sheave is free to rotate to a braking position in which the brake contacts the sheave so as to slow or stop rotation of the sheave.

### FOREIGN PRIORITY

This application claims priority to European Patent Application No. 22383242.9, filed Dec. 20, 2022, and all the benefits accruing therefrom under 35 U.S.C. § 119, the contents of which in its entirety are herein incorporated by reference.

### TECHNICAL FIELD

This disclosure relates to a governor assembly for an elevator, such as a governor assembly employing a centrifugal governor.

### BACKGROUND

A common challenge in elevator design is engineering safety systems to prevent or react to elevator malfunction. One such safety system is the speed governor. An elevator speed governor is a component in an automated elevator safety system which is actuated when an elevator car or counterweight exceeds a set speed or acceleration and either signals a control system to stop or slow down the elevator car or directly engages a safety linkage connected to safety brakes so as to engage the safety brakes and stop the car. One type of governor is a centrifugally actuated governor.

Some centrifugal governors used in elevator systems include two masses, sometimes referred to as fly-weights, connected kinematically in an opposing configuration by links and pinned to a tripping sheave (hereinafter referred to as a sheave) rotating about a common axis. These interconnected parts create a governor mechanism, which rotates at an angular velocity common with the angular velocity of the sheave. The angular velocity of the rotating masses results in a centrifugal force acting to propel the masses away from the common axis. The movement of the masses is essentially a cantilevering motion radially outward about their pinned attachments to the sheave. A coupler prevents the radially outward movement of the masses up to a set centrifugal force (that is, up to a set elevator car speed). The coupler commonly includes a spring connected between the sheave and one of the masses, which resists the centrifugal force generated by the angular velocity of the rotating sheave and masses up to a set speed. When the elevator car reaches (in other words, meets) or exceeds a set speed limit, sometimes referred to as an overspeed condition, the governor is actuated. This is due to the force of the coupler being overcome by the centrifugal force acting on the masses at the set speed limit such that the two masses move radially outward. In some arrangements, the two masses may engage a sensor which in turn signals the elevator system to interrupt power to the elevator drive machine and/or to release a brake to stop the elevator car. If this is ineffective, the elevator car will continue moving and, on the elevator car reaching a higher speed, the two masses may move further radially outward, engaging with and activating a mechanical brake provided on the sheave which slows or stops the rotation of the sheave to cause safety brakes to be activated. One such mechanical brake is described for example in EP 3 202 698 A1 and includes a swing jaw mounted to a sheave which engages with a ratchet disc to restrict rotation of the sheave.

The present disclosure seeks to provide an alternative to such mechanical brakes.

### SUMMARY

According to a first aspect of this disclosure there is provided a governor assembly for an elevator system, the governor assembly comprising: a sheave configured to rotate about a central axis thereof at a speed related to the speed of movement of an elevator car; a plurality of masses mounted to the sheave for rotation therewith about the central axis and configured to move from a first radial position to a second radial position, radially outward of the first radial position, when a speed of rotation of the sheave meets or exceeds a set speed; a sensor configured to detect that the plurality of masses have reached the second radial position; and a brake moveable from a non-braking position in which the sheave is free to rotate to a braking position in which the brake contacts the sheave so as to slow or stop rotation of the sheave, wherein the brake is configured to be moved from the non-braking position to the braking position when the sensor detects that the plurality of masses have reached the second radial position.

It will be understood that the governor assembly according to the disclosure uses a sensor to determine that the brake should be engaged. This may enable a governor assembly according to the disclosure to be controlled and or tested remotely. It may also enable a simpler design of governor assembly with fewer mechanical parts which may fail to be provided. It will also be understood that the governor assembly according to the disclosure may be a bidirectional governor assembly. In other words, the governor assembly according to the disclosure may be configured to move the brake from the non-braking position to the braking position when a speed of rotation of the sheave meets or exceeds a set speed in either a first direction or a second direction, opposite to the first direction.

The governor assembly could be designed so as to only engage the brake when the set speed corresponding to the second radial position of the masses is reached. In other examples however, it is desirable to provide a second safety mechanism in which for example, power may first be cut to an elevator drive when an overspeed condition is detected and then further action, such as for example, engaging safety brakes to stop the movement of an elevator car can be taken if still required. In any example of the disclosure therefore , the plurality of masses may further be configured to move from the first radial position to an intermediate radial position, wherein the intermediate radial position is radially outward of the first radial position and radially inward of the second radial position, when a speed of rotation of the sheave meets or exceeds a threshold speed lower than the set speed.

If required, the governor assembly may comprise a further sensor configured to detect that the plurality of masses have reached the intermediate radial position, and the governor may be configured to signal the elevator system to interrupt power to an elevator drive machine when the further sensor detects that the plurality of masses have reached the intermediate radial position.

It will be understood that the brake may take any desired form and could for example be moved into the braking position by an electromechanical actuator. In various examples of the disclosure however, an electromagnetic type brake may be provided. Such a brake can be activated reliably and simply by a signal or change in power from a power supply. In any example of the disclosure, the brake may comprise: a brake pad moveable between a non-braking position spaced from the sheave and a braking position in contact with the sheave; at least one biasing member configured to apply a biasing force to the brake pad to bias the brake pad towards the non-braking or the braking position; and an electromagnet.

The brake pad may comprise a ferromagnetic material and the electromagnet may be operable to apply a magnetic field to the pad and thereby create a magnetic force acting against the biasing force such that the brake pad is configured to move from the non-braking position to the braking position when the electromagnet is switched from a first state to a second state.

In some examples of the disclosure, the brake could be configured such that the brake was biased into the non-braking position and an electromagnetic force was required to move the brake into the braking position. In various examples however, the biasing member may be configured to bias the brake pad into the braking position.

In any example of the disclosure, the brake may be configured to hold the brake pad in the non-braking position when the electromagnet is powered on in the first state and to move the brake pad to the braking position when the electromagnet is powered off in the second state. This may allow a fail-safe situation in which the brake is automatically engaged in the event of a system or power failure.

In any example of the disclosure, the sheave may comprise a first face and a second face axially spaced from the first face, and the brake pad may be configured to be biased against at least part of the first face when in the braking position. It will be understood that an increase in the contact area between the brake pad and the sheave may improve the braking efficiency of the brake such that the brake pad contacting a relatively smooth planar surface of the sheave may be advantageous at least in some examples.

In any example of the disclosure, the brake may comprise a mounting portion for mounting the brake to the governor assembly and the brake pad may be moveable relative to the mounting portion.

In some examples, the sheave may be fixed in the axial direction, for example by the manner in which it is mounted on a shaft for rotation. In such examples, no further support would need to be provided. At least in some examples however, the brake may comprise a support, and the brake may be configured to bias at least part of the sheave against the support when in the braking position. It will be understood that the support may provide a reaction force against the bias force acting on the sheave, thus improving the braking efficiency of the brake at least in some examples.

In any example of the disclosure, the brake may comprise a stay, and the biasing member may extend between the stay and the brake pad. This may be advantageous in various examples including those in which the biasing member is a compression spring.

In any example of the disclosure, the brake may comprise a guide rod for limiting rotation of the brake pad as it moves into the braking position, and/or for guiding movement of the brake pad into or out of the braking position.

At least in some examples, the guide rod may extend axially outwardly from the brake pad and may be configured to extend through an axial opening in the electromagnet.

It will be understood that a governor assembly according to the disclosure could be used in many different elevator systems. According to a further aspect of the disclosure, an elevator system comprising an elevator car driven to move along at least one guide rail, and a governor assembly according to any example of the disclosure is provided, wherein the sheave is connected to the elevator car by a rope configured to drive rotation of the sheave at a speed related to the speed of movement of the elevator car. In any example of the disclosure, the rope may be a rope, a cable or a belt.

According to any example of the disclosure, a governor assembly according to the disclosure could be used to activate a safety brake in an elevator system when an overspeed condition is detected. In any example therefore, the elevator system may comprise a safety brake moveable between a non-braking position where the safety brake is not in engagement with the guide rail and a braking position where the safety brake is engaged with the guide rail. When the brake acts to slow or stop rotation of the sheave the safety brake can therefore be moved into the braking position.

According to a further aspect of the disclosure, a method of operating a safety brake in an elevator system is provided. The safety brake is moveable between a first position where the safety brake is not in engagement with a guide rail and a second position where the safety brake is engaged with a guide rail. The elevator system comprises an elevator car driven to move along at least one guide rail, and a governor assembly comprising: a sheave configured to rotate about a central axis thereof and connected to the elevator car by a rope configured to drive rotation of the sheave at a speed related to the speed of movement of the elevator car; a plurality of masses mounted to the sheave for rotation therewith about the central axis and configured to move from a first radial position to a second radial position, radially outward of the first radial position, when a speed of rotation of the sheave meets or exceeds a set speed; a sensor configured to detect that the plurality of masses have reached the second radial position; and a brake moveable from a non-braking position in which the sheave is free to rotate to a braking position in which the brake contacts the sheave so as to slow or stop rotation of the sheave. The brake is configured to be moved from the non-braking position to the braking position when the sensor detects that the plurality of masses have reached the second radial position. The method comprises: operating the brake in the non-braking position when the sensor does not detect that the plurality of masses have reached the second radial position; and when the sensor detects that the plurality of masses have reached the second radial position, moving the brake into the braking position so as to slow rotation of the sheave relative to the speed of movement of the elevator car and to cause the safety brake to be moved into the second position.

In any example of the disclosure, the rope may be fixed to a lever which is connected to the safety brake such that relative movement between the rope and the elevator car due to the brake slowing rotation of the sheave may cause the lever to be pulled in a direction opposite to the direction of movement of the elevator car so as to engage the safety brake.

It will be understood that, in any example of the disclosure, engaging the safety brake may cause the movement of the elevator car to be stopped.

In at least some examples of the disclosure, the direction of movement of the elevator car may be a downwards direction and the lever may be pulled upwardly to engage the safety brake.

In any method according to the disclosure, the brake may comprise: a brake pad moveable between a non-braking position spaced from the sheave and a braking position in contact with the sheave; at least one biasing member configured to apply a biasing force to the brake pad to bias the brake pad towards the non-braking or the braking position; and an electromagnet, wherein the brake pad comprises a ferromagnetic material and the electromagnet is operable to apply a magnetic field to the pad and thereby create a magnetic force acting against the biasing force, wherein operating the brake in the non-braking position comprises operating the electromagnet in a first state, and the electromagnet is switched from a first state to a second state to move the brake into the braking position.

In various examples, the electromagnet may be powered on in the first state and the electromagnet may be switched to the second state by selectively reducing or disconnecting an electrical power supply to the electromagnet. This may provide a fail-safe mode of operation in which the brake is automatically engaged when there is a power failure or other system failure which reduces the power supply to the electromagnet.

### DRAWING DESCRIPTION

Some examples of this disclosure will now be described, by way of example only, with reference to the accompanying drawings, in which:

FIG. 1 is a schematic perspective view of an elevator system including a governor assembly;

FIG. 2 is a schematic view of part of a governor assembly according to an example of the disclosure;

FIG. 3 is a schematic sectional view of the part of the governor assembly of FIG. 2;

FIG. 4A is a schematic sectional view of a brake of a governor assembly according to an example of the disclosure when in a non-braking position;

FIG. 4B is a schematic sectional view of the brake of FIG. 4B when in a braking position; and

FIG. 5 is a schematic sectional view of a brake of a governor assembly according to another example of the disclosure.

### DETAILED DESCRIPTION

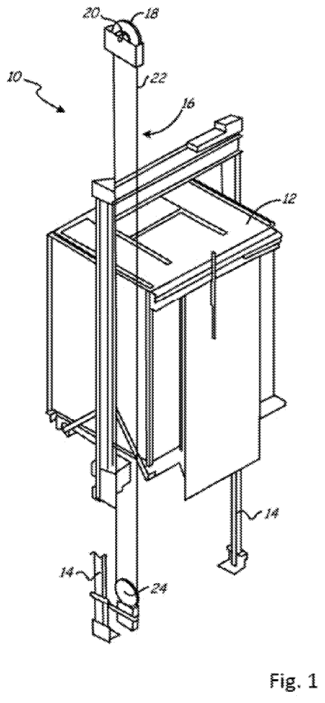

FIG. 1 shows a typical elevator system 10 including an elevator car 12, guide rails 14 and a governor assembly 16. The governor assembly 16 includes a sheave or tripping sheave 18, a governor 20, a rope loop 22, and a tensioning sheave 24. The elevator car 12 travels on or is slidably connected to the guide rails 14 and travels within a hoistway (not shown). Various components of the elevator system 10 have been omitted for clarity, but it will be appreciated that the elevator system 10 may include other standard components including but not limited to a drive means, a tension member, a counterweight, a controller and a plurality of elevator landing doors.

The tripping sheave 18 and the governor 20 are mounted, at least in some examples of the disclosure, at an upper end of the hoistway. The rope loop 22 is wrapped partially around the tripping sheave 18 and partially around the tensioning sheave 24 (which at least in some examples of the disclosure is located at a bottom end of the hoistway). The rope loop 22 is also connected to the elevator car 12, ensuring that the angular velocity of the tripping sheave 18 is related to the speed of the elevator car 12.

In the elevator system 10 of FIG. 1, the governor assembly 16 acts to prevent the elevator car 12 from exceeding a set speed as it travels in the hoistway. Although the governor assembly 16 is shown in FIG. 1 as being mounted at an upper end of the hoistway, the location and arrangement of the governor assembly 16 may vary in other examples. For example, the governor assembly 16 may be mounted at practically any point along the rope loop 22 in the hoistway, including at the bottom of the hoistway, for example in the pit. In other examples, the governor assembly 16 may for example be mounted to and move with the elevator car 12. Such examples may involve a static rope anchored at the top and bottom of the hoistway and wrapped partially around the tripping sheave 18 and an adjacent idler sheave.

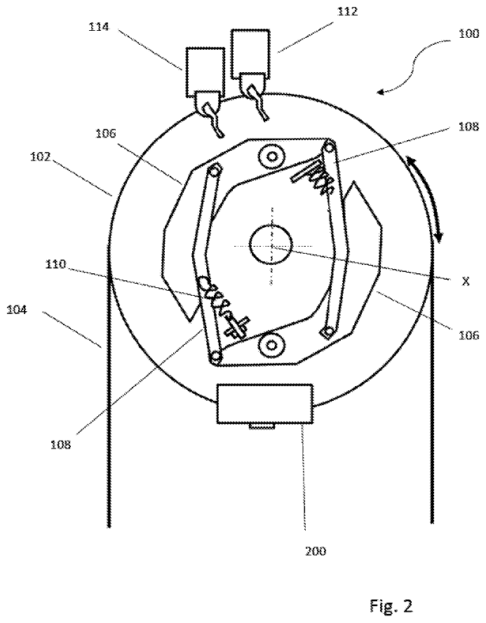

FIG. 2 is a schematic side view of part of a governor assembly 100 according to an example of the disclosure which may be used in an elevator system such as for example, an elevator system 10 of the type shown in FIG. 1 and described above.

The governor assembly 100 includes a sheave 102, in some examples a tripping sheave, which has a central axis X-X. The sheave 102 is configured to rotate about the central axis X-X at a speed related to the speed of movement of an elevator car (not shown in FIG. 2) which is attached to the rope 104 which extends around at least part of the sheave 102 and drives the rotation thereof. In other examples (not shown), a rope which extends around at least part of the sheave and drives the rotation thereof may be attached to a counterweight of the elevator system so as to drive the sheave to rotate about the central axis thereof at a speed related to the speed of movement of an elevator car. It will further be understood that in any example of the disclosure, the rope may be any suitable means including also a cable or a belt.

A plurality of masses 106 are mounted to the sheave 102 for rotation therewith about the central axis X-X and may form a triggering mechanism. In the example shown there are two such masses 106 but it will be understood that any suitable number of two or more masses 106 can be provided as required. The masses 106 are mounted and configured to move from a first radial position (as seen in FIG. 2) to a second radial position (not shown), radially outward of the first radial position, when a speed of rotation of the sheave 102 meets or exceeds a set speed. At least in some examples, this may be achieved by the masses 106 being joined together by first and second linkages 108 each pivotably connected between the first and second masses 106 and by a respective spring coupler 110 attached between the sheave 102 and each of the respective linkages 108 such that the spring couplers 110 bias the first and second masses 106 radially inwardly against the centrifugal forces acting to push the masses 106 radially outwardly as a result of the rotation of the sheave 102. It will be understood that in any example of the disclosure the masses 106, linkages 108 and spring couplings 110 can be configured such that the masses will move radially outwardly by a varying known distance depending on the speed of rotation of the sheave 102. Thus, the masses 106 may be configured to move radially outwardly to the second radial position (not shown), radially outward of the first radial position, when a speed of rotation of the sheave 102 meets or exceeds a set speed.

In any example of the disclosure, the governor assembly 100 includes a sensor 112 which is configured to detect that the masses 106 have reached the second radial position. In other words the sensor 112 may be configured to sense when the speed of rotation of the sheave 102 meets or exceeds the set speed described above. At least in some examples, the sensor 112 is positioned relative to the sheave 102 and configured to come into contact the masses 106 when they reach the second radial position. In other words, when the mases 106 are at a radial position which is radially inward of the second radial position, there will be no contact between the sensor 112 and the masses 106. When the masses 106 are at a radial position which corresponds to or is radially outward of the second radial position, there will however be contact between the sensor 112 and the masses 106. In other words, the sensor will then touch at least one of the masses 106 as the masses 106 rotate. In any example of the disclosure, the sensor 112 can be any device that can signal a change in state such as for example, a mechanically activated electrical switch. In some examples of the disclosure, the sensor 112 can be a mechanically activated electrical switch which switches off a power supply to a brake 200 of the governor assembly 100 as will be described in further detail below.

In any example of the disclosure, the governor assembly 100 may include a further sensor 114. The further sensor 114 can be configured to detect that the masses 106 have reached an intermediate radial position (not shown) which is radially inward of the second radial position and radially outward of the first radial position. At least in some examples, the further sensor 114 can comprise a switch, such as an SOS switch, and the governor assembly 100 can be configured to signal an elevator system to interrupt power to an elevator drive machine when the further sensor 114 detects that the plurality of masses 106 have reached the intermediate radial position.

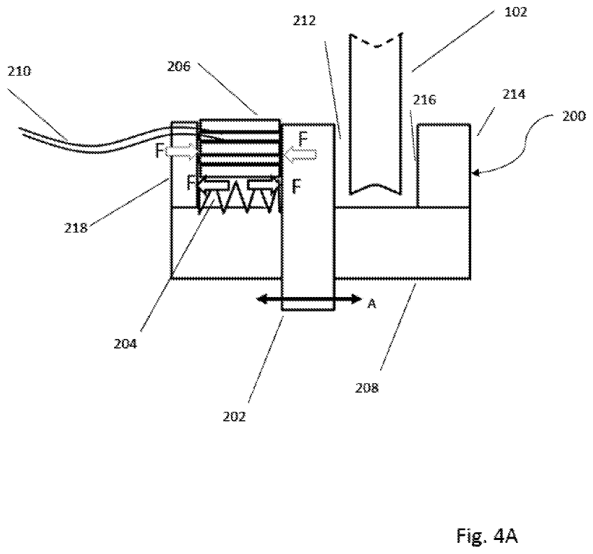

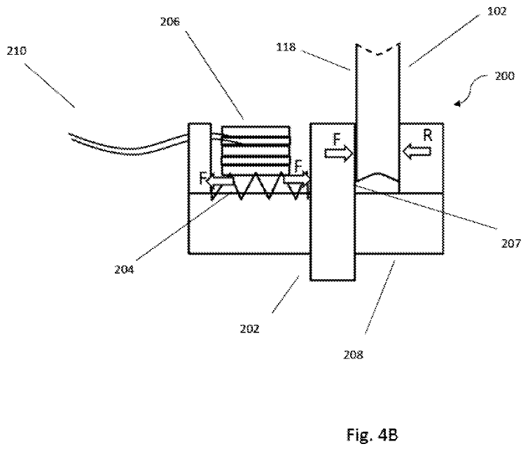

The governor assembly 100 also includes a brake 200 moveable from a non-braking position in which the sheave 102 is free to rotate (as shown in FIG. 4A and described further below) to a braking position (as shown in FIG. 4B and described further below) in which part of the brake 200 contacts the sheave 102 so as to slow or stop rotation of the sheave 102. The brake 200 is configured to be moved from the non-braking position to the braking position when the sensor 112 detects that the plurality of masses 106 have reached the second radially outer position.

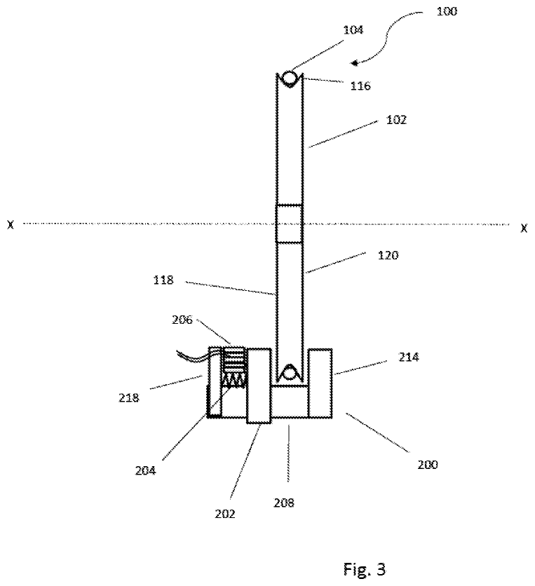

FIG. 3 is a cross sectional view through the governor assembly 100 of FIG. 2 and shows the sheave 102 extending above and below the central axis X-X about which it may rotate. It will be understood that for reasons of clarity, the masses 106 together with the other parts of the triggering mechanism and the sensors 112, 114 are not shown in FIG. 3. The rope 104 is positioned in a groove 116 extending circumferentially around the sheave 102. The sheave 102 may be solid or hollow and may be disc shaped. The sheave 102 can have a first face 118 which can be substantially flat or planar and can be circular in shape. The sheave 102 may also have a second face 120, spaced from the first face 118 in the direction of the central axis X-X (the axial direction), which can be substantially flat or planar and can be circular in shape.

The brake 200 is shown in further detail and described with reference to FIGS. 4A and 4B. As seen in FIG. 3, the brake 200 may be positioned to extend under and around a part of the sheave 102. It will be understood however that the brake 200 could be positioned at any suitable height on the sheave 102, including at the upper part thereof. In any example of the disclosure, the brake may include a brake pad 202, a biasing member 204 and an electromagnet 206. In any example, the biasing member 204 may be a spring, for example a compression spring.

The brake pad 202 is moveable between a non-braking position (as shown in FIG. 4A) in which it is spaced from the sheave 102 and a braking position (as shown in FIG. 4B) in which it is in contact with the sheave 102, for example in contact with the first face 118 of the sheave 102. The brake pad 202 can have a high friction surface on a first face 207 thereof which is arranged to contact the sheave 102 when in the braking position. It will be understood that friction generated between the rotating sheave 102 and the non-rotating brake pad 202 due to the contact between the first face 118 of the sheave 102 and the first face 207 of the brake pad 202 causes a braking action, in other words, the friction generated acts to slow or stop the rotation of the sheave 102.

At least in some examples of the disclosure, the brake 200 comprises a mounting portion 208 for supporting the brake pad 202 . In any example of the disclosure, the brake pad 202 can be moveable relative to the mounting portion 208. At least in some examples, the mounting portion 208 extends in the direction of the central axis X-X and the brake pad 202 is moveable backward and forward, in first and second opposing directions along the axial direction as shown by the arrow A in FIG. 4A.

FIG. 4A shows the brake 200 in a non-engaging or non-braking position, e.g. upon initial installation, when the elevator car is moving but there is no overspeed condition or after reset. The brake 200 can be mounted onto the governor assembly 100 such that the brake 200 is held level with the sheave 102. In the example shown, the biasing member 204 provides a biasing force which biases the brake pad 202 towards the sheave 102. When the electromagnet is powered on, the brake pad 202 is held away from the sheave 102 by a magnetic force provided by the electromagnet 206 which overcomes the biasing force provided by the biasing member 204. In this arrangement, the brake pad 202 can be moved into the braking position when power to the electromagnet 206 is cut. This may enable the governor assembly 100 to act in a fail-safe manner in which a loss of power would result in the brake 200 being engaged.

It will be understood that in other examples which are not shown, the arrangement can be reversed such that the biasing member provides a biasing force which biases the brake pad 202 way from the sheave 102. In this arrangement, when the electromagnet 206 is powered off, the brake pad 202 is held in the non-braking position. The brake pad 202 is then moved into engagement with the sheave 102 (in other words, into the braking position) by a magnetic force provided by the electromagnet 206 when the electromagnet 206 is powered on which overcomes the biasing force provided by the biasing member 204.

In any example, the electromagnet 206 may comprise a ‘G-shaped’ iron core (not shown) and an electrical coil. A power supply (not shown) is configured to control a supply of electricity to the electromagnet 206. The electricity may be provided via a wired connection 210. In other examples, it may be provided by other means including but not limited to a wireless connection. In any example of the disclosure and as described above, the sensor 112 can be a mechanically activated electrical switch which switches the power supply to the electromagnet 206 on or off. At least in some examples including the example of FIG. 3, the sensor 112 can be a mechanically activated electrical switch configured to cut the power supply to the electromagnet 206 when the masses 206 reach the second radial position so as to activate the brake by moving the brake pad 202 into engagement with the sheave 102 when the sheave rotation speed reaches or exceeds the set speed, in other words when an overspeed condition is identified.

In other examples, the sensor could not be mechanically activated but could instead be a non-contact sensor such as, for example, a Hall Effect sensor, the sensor being configured to detect one of the masses moving into proximity with it, in other words to detect that at least one of the masses has reached the second radial position.

In any example, when the brake 200 is in a non-braking position, as shown in FIG. 4A, the brake pad 202 is in a first position and not in contact with the sheave 102, such that there is a gap 212 between the brake pad 202 and the sheave 102. When the brake 200 is in the braking position, as shown in FIG. 4B, the brake pad 202 is in a second position and in contact with the sheave 102, such that there is no gap between the brake pad 202 and the sheave 102.

In any example of the disclosure and as shown in FIGS. 3, 4A and 4B, the brake 200 may include a support 214. At least in some examples, the support 214 is fixed to the mounting portion 208 and positioned to extend parallel to and spaced from the brake pad 202. When the brake pad 202 is in the braking position, the brake is configured to bias the sheave 102 towards the support 214 such that the sheave 102 is in contact with both the support 214 and the brake pad 202, the second face 120 of the sheave 102 being in contact with the support 214 and the first face 118 of the sheave 102 being in contact with the brake pad 202. At least in some examples, the support 214 can have a high friction surface on a first face 216 thereof which is arranged to contact the second face 120 of the sheave 102 when in the braking position.

It will be understood that the support 214 may increase the braking efficiency of the brake for a given biasing force provided by the biasing member 204. This is discussed with reference to the example of FIG. 4B. When in the braking position, the biasing force F will act to bias the brake pad 202 against the sheave 102 with a resulting frictional force providing braking of the sheave rotation. In addition, an equal and opposite reaction force R from the support 214 will act to push back against the sheave 102 with a resulting additional frictional force providing braking of the sheave rotation. It will be understood therefore that the magnitude of the force acting on the sheave 102 to create friction may be equivalent to 2F (or F+R) whereas the force required to be exerted by the electromagnet 206 to hold the brake pad 202 away from the sheave 102 need only be equal and opposite to the biasing force F.

In any example of the disclosure and as shown in FIGS. 3, 4A and 4B, the brake 200 may include a stay 218. At least in some examples, the stay 218 is fixed to the mounting portion 208 and positioned to extend parallel to and spaced from the brake pad 202. The biasing member 204 is connected between the brake pad 202 and the stay 218.

Although other arrangements are possible, in the example shown, the brake 200 is configured such that a part of the sheave 102 (in this example, the lower part thereof) extends into the brake 200 and is positioned between the support 214 and the brake pad 202. The stay 218 is then axially spaced from and positioned on the other side of the brake pad 202 from the support 214. The mounting portion 208 extends below the sheave 102 in the axial direction. The support 214 and/or the stay 218 are supported by and extend upwardly from the mounting portion 208. It will be understood that support 214 and/or the stay 218 can either be formed integrally with the mounting portion 208 or fixed thereto by any suitable means, including but not limited to fixing means such as rivets or welding. In any example of the disclosure, the axial spacing between the support 214 and the stay 218 may remain constant, at least in some examples due to the support 214 and the stay 218 being axially fixed relative to the mounting portion 208.

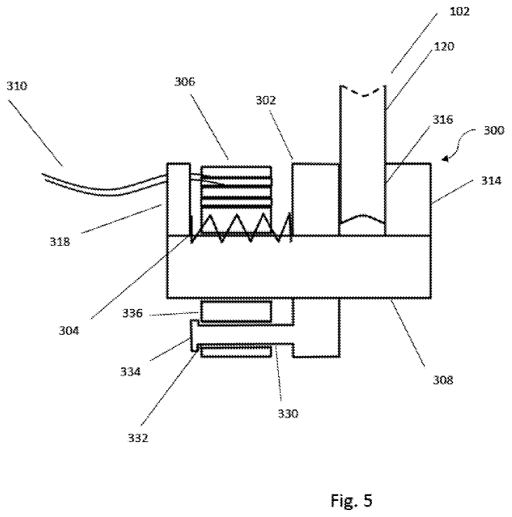

An alternative example of a brake is shown in FIG. 5. The brake 300 of FIG. 5 is similar in construction to the brake 200 of FIGS. 4A and 4B. FIG. 5 shows the brake 300 in a braking position in which a sheave 102 is held between a brake pad 302 and a support 314. The brake 300 includes all the components of the brake of FIGS. 4A and 4B, each of which are substantially the same and function in substantially the same manner. Thus, the brake 300 includes a brake pad 302, a biasing member 304, an electromagnet 306, a mounting portion 308, a wired connection 310, a support 314 and a stay 318. As before, the support 314 can have a high friction surface on a first face 316 thereof which is arranged to contact the second face 120 of the sheave 102 when in the braking position.

As seen in FIG. 5, the brake 300 of this example also includes a guide rod 330 which extends axially outwardly from the brake pad 302 and is configured to extend through an axial opening 332 in the electromagnet 306 so as to guide axial movement of the brake pad 302 relative to the electromagnet 306 and the mounting portion 308. The guide rod 330 may also act to limit or stop rotation of the brake pad 302 as it is moved in the axial direction by the force exerted by the biasing member 304. It will be understood that, in any example of the disclosure, the guide rod 330 may be spaced from the mounting portion 308 and/or the biasing member 304 in a direction substantially perpendicular to the axial direction or the direction of movement of the brake pad 302. It will be understood that this will allow the guide rod 330 to more effectively resist any rotation of the brake pad 302 under the effect of the biasing member 304.

A stop member 334 may further be provided at the end of the guide rod 330 removed or spaced from the brake pad 302 such that movement of the brake pad 302 away from the electromagnet 306 is limited by the engagement of the stop member 334 with an outer wall 336 of the electromagnet 306.

In any example of the disclosure, the brake 200, 300 may be fixed to the governor assembly 100 via the electromagnet 206, 306 as this is a part of the brake 200, 300 that does not move axially relative to the sheave 102.

In use, the brake 200, 300 engages with the sheave 102 to slow or stop rotation of the sheave 102. It will be understood that the elevator car 12 to which the rope 104 is attached will still be moving after the brake 200, 300 engages with the sheave 102, thus causing the rope 104 to move upwardly relative to the elevator car 12. The rope 104 may be fixed to a lever (not shown), which is in turn connected to one or more safety brakes (not shown). The relative movement between the rope 104 and the elevator car 12 may therefore cause the lever to be pulled upwardly so as to engage one or more safety brakes (not shown) to stop downward movement of the elevator car 12.

A method of operating a safety brake (not shown) in an elevator system 10 using a governor assembly 100 according to the disclosure is also provided. A safety brake in an elevator system 10 is typically moveable between a first position where the safety brake is not in engagement with a guide rail 14 and a second position where the safety brake is engaged with a guide rail 14, the safety brake acting to stop movement of an elevator car 12 along a guide rail 14 when moved into the second position to initiate an emergency stop mode.

The method includes operating the governor assembly brake 200, 300 in the non-braking position when the sensor 112 does not detect that the plurality of masses 106 have reached the second radial position; and when the sensor 112 detects that the plurality of masses 106 have reached the second radial position, moving the governor assembly brake 200, 300 into the braking position so as to slow rotation of the sheave 102 relative to the speed of movement of the elevator car 12 and to cause the safety brake to be moved into the second position.

In a governor assembly 100 such as that shown at least in part in FIGS. 3, 4A, 4B and 5, operating the brake 200, 300 in the non-braking position comprises operating the electromagnet 206, 306 in a first state, for example in which the electromagnet 206, 306 is powered on to exert an electromagnetic force on the brake pad 202, 302 to hold it in the non-braking position. The electromagnet 206, 306 is then switched from the first state to a second state to move the brake 200, 300 into the braking position. In the example shown the electromagnet 206, 306 is switched to the second state by selectively reducing or disconnecting an electrical power supply (not shown) to the electromagnet 206, 306. This may be achieved by providing a connection between the sensor 112 (in this example a switch) such that when the switch (sensor 112) comes into contact with one of the plurality of masses 106, a power supply to the electromagnet 206, 306 is switched off or cut, thus causing the brake pad 202, 302 to move into the braking position.

In any example of the disclosure, the sheave 102 may be made of any suitable material including metals and also plastics. The use of plastic may result in a cost saving in manufacturing the governor assembly 100 according to the disclosure.

It will be understood that the governor assembly 100 according to various examples of the disclosure may be used to detect an overspeed condition for both upwards and downwards motion or motion in any other direction of an elevator car 12. In various examples, the governor assembly 100 according to the disclosure may be a bidirectional governor assembly. In other words, the governor assembly 100 according to the disclosure may be configured to move the brake 200, 300 from the non-braking position to the braking position when a speed of rotation of the sheave 102 meets or exceeds the set speed in either a first direction or a second direction, opposite to the first direction.

The governor assembly 100 according to the disclosure may be reset simply by changing the state of the electromagnet 206, 306 so as to move the brake pad 202, 302 from the braking position back to the non-braking position. In any example, a controller (not shown) may be provided to produce a signal to change the state of the electromagnet 206, 306 and reset the brake 200, 300 to the non-braking position when required. In any example, the controller may be controlled remotely by maintenance personnel or an automated system.

The governor assembly 100 according to the disclosure may be controlled and/or tested remotely, thus for example reducing the need for maintenance personnel to attend an elevator site and thus reducing running costs of an elevator system 10 using a governor assembly 100 according to the disclosure.

In various examples of the disclosure, the geometry of the sheave 102 may be simpler than that required by known governor assemblies thus resulting in a reduction in manufacturing costs.

It will be appreciated by those skilled in the art that the disclosure has been illustrated by describing one or more examples thereof, but is not limited to these examples; many variations and modifications are possible, within the scope of the accompanying claims.

What is claimed is:

1. A governor assembly (100) for an elevator system (10), the governor assembly (100) comprising:
a sheave (102) configured to rotate about a central axis (X-X) thereof at a speed related to the speed of movement of an elevator car (12);
a plurality of masses (106) mounted to the sheave (102) for rotation therewith about the central axis (X-X) and configured to move from a first radial position to a second radial position, radially outward of the first radial position, when a speed of rotation of the sheave (102) meets or exceeds a set speed;
a sensor (112) configured to detect that the plurality of masses (106) have reached the second radial position; and
a brake (200; 300) moveable from a non-braking position in which the sheave (102) is free to rotate to a braking position in which the brake (200; 300) contacts the sheave (102) so as to slow or stop rotation of the sheave (102),
wherein the brake (200; 300) is configured to be moved from the non-braking position to the braking position when the sensor (112) detects that the plurality of masses (106) have reached the second radial position.

2. A governor assembly (100) as claimed in claim 1, wherein the plurality of masses (106) are configured to move from the first radial position to an intermediate radial position, wherein the intermediate radial position is radially outward of the first radial position and radially inward of the second radial position, when a speed of rotation of the sheave (102) meets or exceeds a threshold speed lower than the set speed.

3. A governor assembly (100) as claimed in claim 2, comprising a further sensor (114) configured to detect that the plurality of masses (106) have reached the intermediate radial position, wherein the governor assembly (100) is configured to signal the elevator system (10) to interrupt power to an elevator drive machine when the further sensor (114) detects that the plurality of masses (106) have reached the intermediate radial position.

4. A governor assembly (100) as claimed in claim 1, wherein the brake (200; 300) comprises:
a brake pad (202; 302) moveable between a non-braking position spaced from the sheave (102) and a braking position in contact with the sheave (102);
at least one biasing member (204; 304) configured to apply a biasing force to the brake pad (202; 302) to bias the brake pad (202; 302) towards the non-braking or the braking position; and
an electromagnet (206; 306),
wherein the brake pad (202; 302) comprises a ferromagnetic material and the electromagnet (206; 306) is operable to apply a magnetic field to the brake pad (202; 302) and thereby create a magnetic force acting against the biasing force such that the brake pad (202; 302) is configured to move from the non-braking position to the braking position when the electromagnet (206; 306) is switched from a first state to a second state.

5. A governor assembly (100) as claimed in claim 4, wherein the biasing member (204; 304) is configured to bias the brake pad (202; 302) into the braking position.

6. A governor assembly (100) as claimed in claim 4, wherein the brake (200; 300) is configured to hold the brake pad (202; 302) in the non-braking position when the electromagnet (206; 306) is powered on in the first state and to move the brake pad (202; 302) to the braking position when the electromagnet (206; 306) is powered off in the second state.

7. A governor assembly (100) as claimed in claim 4, wherein the sheave (102) comprises a first face (118) and a second face (120) axially spaced from the first face (118), wherein the brake pad (202; 302) is configured to be biased against at least part of the first face (118) when in the braking position.

8. A governor assembly (100) as claimed in claim 4, wherein the brake (200; 300) comprises a mounting portion (208; 308) and wherein the brake pad (202; 302) is moveable relative to the mounting portion (208; 308).

9. A governor assembly (100) as claimed in claim 4, the brake (200; 300) comprising a support (214; 314), wherein the brake (200; 300) is configured to bias at least part of the sheave (102) against the support (214; 316) when in the braking position.

10. A governor assembly (100) as claimed in claim 4, the brake (200; 300) comprising a stay (216; 316), wherein the biasing member (204; 304) extends between the stay (216; 316) and the brake pad (202; 302).

11. An elevator system (10) comprising an elevator car (12) driven to move along at least one guide rail (14), and a governor assembly (100) as claimed in claim 1, wherein the sheave (102) is connected to the elevator car (12) by a rope (22; 104) configured to drive rotation of the sheave (102) at a speed related to the speed of movement of the elevator car (12).

12. An elevator system (10) as claimed in claim 11, comprising a safety brake moveable between a non-braking position where the safety brake is not in engagement with the guide rail (14) and a braking position where the safety brake is engaged with the guide rail (14),
wherein when the brake (200; 300) acts to slow or stop rotation of the sheave (102) the safety brake is moved into the braking position.

13. A method of operating a safety brake in an elevator system (10), the safety brake moveable between a first position where the safety brake is not in engagement with a guide rail (14) and a second position where the safety brake is engaged with a guide rail (14),
the elevator system (10) comprising an elevator car (12) driven to move along at least one guide rail (14), and a governor assembly (100) comprising:
a sheave (102) configured to rotate about a central axis (X-X) thereof and connected to the elevator car (12) by a rope (22; 104) configured to drive rotation of the sheave (102) at a speed related to the speed of movement of the elevator car (12);
a plurality of masses (106) mounted to the sheave (102) for rotation therewith about the central axis (X-X) and configured to move from a first radial position to a second radial position, radially outward of the first radial position, when a speed of rotation of the sheave (102) meets or exceeds a set speed;
a sensor (112) configured to detect that the plurality of masses (106) have reached the second radial position; and
a brake (200; 300) moveable from a non-braking position in which the sheave (102) is free to rotate to a braking position in which the brake (200; 300) contacts the sheave (102) so as to slow or stop rotation of the sheave (102),
wherein the brake (200; 300) is configured to be moved from the non-braking position to the braking position when the sensor (112) detects that the plurality of masses (106) have reached the second radial position,
the method comprising:
operating the brake (200; 300) in the non-braking position when the sensor (112) does not detect that the plurality of masses (106) have reached the second radial position; and
when the sensor (112) detects that the plurality of masses (106) have reached the second radial position, moving the brake (200; 300) into the braking position so as to slow rotation of the sheave (102) relative to the speed of movement of the elevator car (12) and to cause the safety brake to be moved into the second position.

14. A method as claimed in claim 13, wherein the brake (200; 300) comprises:
a brake pad (202; 302) moveable between a non-braking position spaced from the sheave (102) and a braking position in contact with the sheave (102);
at least one biasing member (204; 304) configured to apply a biasing force to the brake pad (202; 302) to bias the brake pad (202; 302) towards the non-braking or the braking position; and
an electromagnet (206; 306),
wherein the brake pad (202; 302) comprises a ferromagnetic material and the electromagnet (206; 306) is operable to apply a magnetic field to the brake pad (202; 302) and thereby create a magnetic force acting against the biasing force,
wherein operating the brake (200; 300) in the non-braking position comprises operating the electromagnet (206; 306) in a first state, and
the electromagnet (206; 306) is switched from a first state to a second state to move the brake (200; 300) into the braking position.

15. A method as claimed in claim 14, wherein the electromagnet (206; 306) is powered on in the first state and the electromagnet (206; 306) is switched to the second state by selectively reducing or disconnecting an electrical power supply to the electromagnet (206; 306).
